(19) United States
(12) Patent Application Publication
(10) Pub. No.: US 2014/0278565 A1
(43) Pub. Date: Sep. 18, 2014

(54) Systems and Methods for Cross Border Health Insurance

(71) Applicant: GLOBEMED LIMITED, Sin El Fil (LB)

(72) Inventors: Mounir Michel Kharma, Horsh Tabet (LB); Jad Geries Moawad, Naccache (LB); Rabih Maurice Kharma, Zouk Mikael (LB)

(73) Assignee: GlobeMed Limited, Sin El Fil (LB)

(21) Appl. No.: 13/837,497

(22) Filed: Mar. 15, 2013

(51) Int. Cl. G06Q 40/08

(52) U.S. Cl. CPC G06Q 40/08
USPC 705/4

(57) ABSTRACT

A system and method for providing healthcare insurance services to a beneficiary outside of a home boundary of the beneficiary, that includes: receiving a request to provide healthcare insurance services to a beneficiary from a healthcare provider at a first location; determining whether the first location of the healthcare provider is within or outside of the home boundary of the beneficiary; and, if the first location is outside of the home boundary of the beneficiary: determining an eligibility of the beneficiary based on the healthcare provider and the first location of the healthcare provider; and providing an insurance coverage amount to the healthcare provider at the first location based on the determination of the eligibility of the beneficiary.

### FIELD OF THE DISCLOSURE

The present disclosure is generally directed toward a method and system for providing healthcare insurance services and, more particularly, toward systems and methods for providing healthcare insurance services to individuals outside of their home country.

### BACKGROUND OF THE DISCLOSURE

Though different in many respects from other types of services, healthcare services and healthcare insurance services are also impacted by globalization. For example, some countries, especially developing ones, can attract customers/patients from other countries by offering high quality healthcare at a lower cost than is available in their home country. In contrast, according to an estimate, the cost of health insurance in the U.S.A. rose between 8.2% and 13.9% per year from 2000 to 2005. Some reports have indicated that rises in healthcare costs in the U.S.A. have outpaced rises in wages. Treatments offered in western Europeans countries attract infertile couples from the United States because they often cost half or one third of those provided in North America. Additionally, elective surgery offered in highly sophisticated Indian hospitals tends to cost only 10-20% of identical treatment in western countries. Thus, it is believed that citizens of the United States and other developed nations are now traveling to other countries in order to save on the costs of healthcare.

In addition, globalization in general has also increased the numbers of business travelers who head outside their home country for work on a regular basis. These business travelers, whether in another country for a short or extended period of time, will likely end up seeking healthcare services at some point. Further, recreational travelers also experience the need for healthcare services from time to time as well.

By traveling to other countries, it is often unclear to an individual how their healthcare insurance effects payment for services in a country different from their home country. In many cases, the legal, regulatory and/or tax schemes or structures in other countries are much different from a home country. Furthermore, there may be transactional barriers to payment, including issues dealing with language differences and/or currency exchanges.

Thus, there is a need for a system and method that allows for easily and efficient handling of claims for healthcare insurance services for healthcare services that are provided outside of a beneficiary's home country or territory.

The present disclosure is directed toward overcoming one or more of the above-identified problems.

### SUMMARY OF THE DISCLOSURE

The present disclosure is directed to systems and methods for providing medical and healthcare insurance services to beneficiaries outside of their home country on a direct payment basis. This may be accomplished using a medical insurance card that is a global access card to receive medical and healthcare services in another country that are covered by a beneficiary's healthcare plan. Additionally, automated handling of approvals and eligibility through one portal for a healthcare provider is also possible. It is an object of the present disclosure to provide beneficiaries with cross border insurance coverage.

A method for providing healthcare insurance services to a beneficiary outside of a home boundary of the beneficiary is disclosed herein. The method comprises receiving, by a computing system including a processor and a data storage medium, a request to provide healthcare insurance coverage services for healthcare services provided, or to be provided, to a beneficiary from a healthcare provider at a first location, determining, by the computing system, whether the first location of the healthcare provider is within or outside of the home boundary of the beneficiary, and, if the first location is outside of the home boundary of the beneficiary, determining an eligibility of the beneficiary based on at least the healthcare provider and the first location of the healthcare provider and providing an insurance coverage amount to the healthcare provider at the first location based on the determination of the eligibility of the beneficiary by the computing system based on the insurance policy issued on a different computing system including a processor and a data storage medium than the one at a first location for this policy in his home country by his healthcare insurance provider.

In another embodiment, the method requires that determining the eligibility of the beneficiary comprises determining, by a computing system, a regulatory structure of the first location applicable to the healthcare services.

In yet another embodiment, the method requires creating a profile for a beneficiary and storing the profile in a database.

In still another embodiment, the method requires that a database is controlled by a healthcare insurer providing the coverage amount to the healthcare provider.

In a further embodiment, the method requires creating a claim for healthcare services provided by a healthcare provider at a first location outside of a home boundary of the beneficiary by referencing information about the beneficiary healthcare policy details in a database in the second location and computing an amount of administrative fees for a cross border claim for the healthcare services.

In still a further embodiment, the method requires that an eligibility of a beneficiary is dependent upon a country in which a first location of a healthcare provider is located.

In yet a further embodiment, the method requires providing a beneficiary with a healthcare access card that provides access to payment for a healthcare services received, or to be received, by the beneficiary outside of a home boundary of the beneficiary.

In another embodiment, the method requires that healthcare services comprise an elective healthcare procedure and that providing the coverage amount comprises determining, by a computing system, the elective healthcare procedure to be provided to the beneficiary.

In yet another embodiment, the method requires that a beneficiary is an enrollee of a coverage program controlled and operated by a healthcare insurer in a second location.

In still another embodiment, the method requires that providing a coverage amount to a healthcare provider at a first location is also based on the healthcare services to be provided to a beneficiary from the healthcare provider.

In a further embodiment, the method requires that a coverage amount is a predetermined coverage amount.

A system for providing healthcare insurance services to a beneficiary outside of a home boundary of the beneficiary is also disclosed herein. The system comprises a computer system comprising at least one processor and an operably connected data storage medium such that the at least one processor is configured for receiving a request to provide healthcare insurance services for healthcare services provided, or to be provided, to a beneficiary from a healthcare provider at a first location. The at least one processor is further configured for determining whether the first location of the healthcare provider is within or outside of the home boundary of the beneficiary and, if the first location is outside of the home boundary of the beneficiary, determining an eligibility of the beneficiary based on at least the healthcare provider and the first location of the healthcare provider and based on the benefits of the insurance policy issued for him in his home country in the second location by his healthcare insurance provider and providing an insurance coverage amount to the healthcare provider at the first location based on the determination of the eligibility of the beneficiary.

In another embodiment, the system requires that at least one processor determines an eligibility of a beneficiary based on at least a regulatory structure of a first location applicable to healthcare services.

In yet another embodiment, the system requires that at least one processor creates a profile for the beneficiary and stores the profile in a database.

In yet another embodiment, the system requires that a computer system is a first computer system and the first computer system receives the request to provide healthcare insurance services for healthcare services provided, or to be provided, to a beneficiary from a second computer device based on a transaction associated with a healthcare access card that provides access to payment for the healthcare services received, or to be received, by the beneficiary outside of the home boundary of the beneficiary.

A method for providing healthcare insurance services to a beneficiary outside of a home country of the beneficiary is further disclosed herein. The method comprises receiving, by a computing system including a processor and a data storage medium, a request to provide healthcare insurance services for healthcare service provided, or to be provided, to a beneficiary from a healthcare provider in a first country, determining, by the computing system, whether the first country of the healthcare provider is within or outside of the home country of the beneficiary and, if the first country is outside of the home country of the beneficiary, determining an eligibility of the beneficiary based on at least the healthcare provider and the first country of the healthcare provider and providing an insurance coverage amount to the healthcare provider at the first country based on the determination of the detailed eligibility for the beneficiary as per the insurance policy issued by the computing system in the second location.

Further, providing the insurance coverage amount comprises determining, by the computing system, at least one of a legal structure of the first country, a regulatory structure of the first country, a taxation structure in the first country, and a type of healthcare services provided, or to be provided, to the beneficiary.

In another embodiment, the method requires that a type of healthcare services comprises at least one of a prescription for medicine, an elective surgical procedure, general physician services, ambulatory services and emergency treatment services.

In yet another embodiment, the method further requires processing, by a computing system, a claim for an insurance coverage amount based on a contract specified for a home country of the beneficiary.

In still another embodiment, the method further requires computing, by a computing system, administration fees for providing an insurance coverage amount to a healthcare provider at the first country based on a determination of an eligibility of a beneficiary in a second location.

In a further embodiment, the method further requires receiving, by a computing system, an endorsement for a beneficiary in a healthcare network operated by a healthcare insurer and updating a database based on the endorsement for the beneficiary.

In still a further embodiment, the method further requires periodically updating a database based on changes in at least one of the legal structure of the first country, the regulatory structure of the first country, a taxation structure in the first country, and types of healthcare services offered in the first country.

Various other objects, aspects and advantages of the present disclosure can be obtained from a study of the specification, the drawings, and the appended claims.

### BRIEF DESCRIPTION OF THE DRAWINGS

The presently disclosed exemplary technical solutions are best understood from the following detailed description when read in connection with the accompanying drawings, to which the claimed invention is not limited. According to common practice, various features/elements of the drawings may not be drawn to scale. Common numerical references represent like features/elements. The following figures are included in the drawings:

FIG. 1 depicts a flowchart for a member enrollment procedure of the present disclosure;

FIG. 2 depicts a flowchart for an adherent eligibility determination procedure of the present disclosure;

FIG. 3 depicts a flowchart for a claim processing adjudication procedure of the present disclosure;

FIG. 4 depicts a flowchart for a claim closing procedure of the present disclosure;

FIGS. 5A-B illustrate network architecture for various embodiments of the present disclosure; and

FIG. 6 depicts an exemplary computer system in which embodiments of the present disclosure may be implemented.

### DETAILED DESCRIPTION

The present disclosure allows members of a healthcare network of a healthcare insurer to benefit from healthcare services wherever they may be traveling in countries where the healthcare network is present.

### DEFINITIONS

The term “adherent” is used herein to mean a member or beneficiary of a healthcare insurance network provided by a healthcare insurance provider or healthcare insurer.

The term “healthcare provider” is used herein to mean an individual or an institution that provides preventive, curative, promotional, and/or rehabilitative healthcare services in a systematic way to individuals, families or communities. This may include hospitals, clinics, primary care centers, and other service delivery points.

The term “healthcare services” is used herein to mean the diagnosis, treatment, and/or prevention of disease, illness, injury, and/or other physical and mental impairments in humans. Healthcare services are delivered by practitioners in medicine, chiropractic, dentistry, optometry, nursing, pharmacy, allied health, and/or by other care providers. These services may include, as a very small set of possible examples: a prescription for medicine, general physician services, an elective or necessary surgical procedure, emergency treatment, etc.

The term “coverage amount” is used herein to mean a financial payment that is made, or is to be made, by a healthcare insurance provider to a healthcare provider on behalf of a beneficiary and may include a predetermined coverage amount for particular healthcare services.

### Enrollment

Initially, a method for providing healthcare insurance services to a beneficiary outside of a home boundary of the beneficiary, also called “cross border coverage” herein, may include the process, shown generally at 100, of enrolling a new member or an existing member of the healthcare insurer's network into the cross border coverage program, as shown in FIG. 1. Areas inside a “home boundary” of the beneficiary and areas outside of the “home boundary” may indicate, for example, a demarcation between countries, between states within a country, cities or municipalities within a state, or further divisions of localities within an area based on governmental or other lines of control or other boundaries.

According to FIG. 1, the process starts at step 102. At 104, a new endorsement is provided on the client system of the healthcare insurer's network for the new or existing member. At step 106, a determination is made as to whether the new endorsement affects the cross border coverage eligibility program provided by a healthcare insurance provider. For instance, if the new or existing member is already enrolled in the cross border coverage program (answer at step 106 is “no”), the method proceeds to step 108. However, if the new endorsement affects the cross border coverage program, then a central adherent or beneficiary database is updated, at step 110.

Upon updating the central adherent database (at step 110) or determining that the new endorsement does not affect the cross border coverage program (at step 106), a determination is made as to whether there are insurance coverage changes for the new endorsement that are effective across the borders of various locations that are part of the cross border coverage program, at step 108. If there are coverage changes that have an affect across the borders, then a central coverage database for the cross border coverage program is updated, at step 112. Upon updating the central coverage database (at step 112) or determining that there are coverage changes that do not have an affect across the borders (at step 108), the process 100 of enrolling a new member or an existing member of the healthcare insurer's network into the cross border coverage program is completed, at step 114.

### Eligibility

As shown in FIG. 2, after a new or existing member is enrolled in the cross border coverage program, an eligibility method 200 is initiated when an adherent requires medical services. The method 200 is initiated at step 202 and includes receiving, at step 204, a request to provide healthcare services to a beneficiary from a healthcare provider at a first location. A beneficiary may be provided with a healthcare access card which facilitates the request to provide healthcare services to the beneficiary.

The healthcare access card provides access to healthcare services to be received by the beneficiary inside or outside of the home boundary of the beneficiary on direct billing basis. With a swipe of the card, similar to that of a credit card, healthcare providers may directly access a beneficiary's insurance policy benefits and requirements. This allows a beneficiary member of the healthcare insurer's network to enjoy medical attention at contracted or agreed to medical facilities, whether the beneficiary is seeking a simple consultation, general or emergency physician services, dental or vision care, pharmacy services, etc., in an expedient manner.

At step 206, it is determined whether the first location of the healthcare provider is within or outside of the home boundary of the beneficiary—in other words, is the adherent or beneficiary local to the first location of the healthcare provider? If the first location of the healthcare provider is local to the adherent or beneficiary, meaning the beneficiary is within the home boundary, a normal eligibility check is undertaken, at step 208, which involves checking the host database of the healthcare insurer. If the healthcare services requested for the beneficiary are eligible, then the request is processed under a normal claim processing procedure, at step 210.

If the first location of the healthcare provider is outside of the home boundary, meaning the first location is not local to the adherent or beneficiary, eligibility for the cross border claim is determined, at step 212. As shown in FIG. 2, initially, a check is made, at step 212, to the adherent central database, shown at 214, to determine if the adherent is enrolled in the cross border coverage program. If, at step 216, the adherent is determined to be outside of the cross border coverage program and ineligible at this point, the process ends, at step 218, and no claim for the request to provide healthcare services is created or processed.

If the adherent is determined to be enrolled in the cross border coverage program and eligible, at step 216, the method proceeds with determining, at step 220, if this is the first encounter with the adherent in the host database. If it is not the first encounter in the host database, a determination is made, at step 222, as to whether the adherent information requires updating. If an update is required, information is received and stored in the host database, at step 224. This information may include any amount of personal information typically collected by a healthcare insurer. Additionally, periodic updates may be made to the host database, and any other databases involved, based on information manually input by the adherent or beneficiary, manually input by an individual associated with the healthcare insurer controlling the database, and/or automatically based on information by the healthcare insurer.

Upon determining that it is the adherent's first encounter in the host database, at step 220, a profile may be created and stored in the host database with default host coverage, at step 226. Creating the adherent profile in the host database, shown at 228, may involve a normal eligibility check, at step 208. The default host coverage may include limitations of the types of healthcare services provided, a coverage amount limit, limitations that only certain locations outside of the home boundary are provided coverage for, or any other limitations, such as, but not limited to, legal, regulatory and/or tax issues specific to certain countries or areas, that may be appreciated by one of ordinary skill in the art.

The method 200 then proceeds with step 230, where the adherent's eligibility for cross border is checked in the central coverage database, the details of the coverage and related claims adjudication rules related to the healthcare policy are retrieved from the client system, shown at 232. Determining the eligibility of the beneficiary at this point may include determining a legal and/or regulatory scheme or structure present in the first location applicable to the healthcare services that are offered or provided by the healthcare provider at the first location. In a preferred embodiment, this may also include determining a taxation scheme or structure in the first location and the type of the healthcare services that are offered by healthcare providers at any possible location and/or those being requested to be provided.

If it is determined that the adherent's claim is eligible at step 234, the method proceeds to a claims creation process, at step 236. If it is determined at step 234 that the adherent's claim is not eligible, the process ends at step 218.

Following a determination that the healthcare services requested for the adherent are eligible at steps 234 and 236, the method proceeds to a claims creation process 300, as shown in FIG. 3. The adherent's claim is initially processed under normal claim processing on the host system using the local contract, obtained from the host database 308, and coverage amounts, obtained from the client database in location where policy was issued 316, at step 306. This may take place on a host system or database 308, which is described below, based on a local contract and a default coverage plan or program.

At the host database 308, the original information regarding the adherent and the requested healthcare services are referenced from the client database, at step 310. If the first location of the healthcare provider is not local to the beneficiary, and outside of the home boundary of the beneficiary, the cross border claim is processed by computing any administration fees for the cross border claim, at step 312.

A claim summary for the cross border, or other, claim is created, at step 314, on the host database 308, which includes the service level and/or type of healthcare services along with a converted amount for the claim summary. The claim summary is based on an original contract between the beneficiary and the health insurer and an original guarantor. At the client database 316, the original information regarding the beneficiary and the requested healthcare services are referenced, at step 318, from the host database 308, and any administration fees for any cross border claims are computed, at step 320. The method 300 then ends at step 322. It is contemplated that in order to expedite the processing of claims, steps 306, 310, 312, 314, 318 and 320 are performed at the healthcare insurance provider in an automated fashion. Once the local or cross border claim has been processed, the method then proceeds to a claim closing procedure shown generally at 400 in FIG. 4. As shown in FIG. 4, the claim closing procedure begins at step 402, and includes performing an audit and normal closing of claims on the host 404, at step 406. A cross border claim may further include interfacing the cross border claim and administration fee amounts to accounting with regard to the host database 404, at step 408. The client database 410 is updated with a final amount, at step 412, and the cross border and other claim is flagged as audited in the client database 410, step 414. It is contemplated that in order to expedite the processing and closing of claims, steps 408, 412 and 414 are performed at the healthcare insurance provider in an automated fashion.

Amounts of the cross border or other claim are validated with the host database 416, at step 418, and the claims are closed in the client database 410, at step 420. Upon closing the claims, the claims and the associated administration fees are interfaced to accounting, at step 422, with regard to the client database 410. The method 400 then ends at step 424.

### Computer System Architecture

Embodiments of the present disclosure may be directed to computer program products comprising software stored on any computer useable medium. Such software, when executed in one or more data processing device, causes a data processing device(s) to operate as described herein. Embodiments of the present disclosure employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

Accordingly, it will be appreciated that one or more embodiments of the present disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

FIGS. 5A, 5B, and 6 illustrate communications network architecture and systems, respectively for providing healthcare insurance services to a beneficiary outside of a home boundary of the beneficiary as discussed and described above. The exemplary communications network architecture and computer systems depicted in FIGS. 5 and 6 may comprise a healthcare insurance provider's or healthcare services provider's communications network and computer system, respectively.

FIGS. 5A and 5B illustrates a system 500 according to embodiments of the present disclosure for providing communication network-based access to insurance payments and coverage for healthcare services for healthcare providers. As shown in FIG. 5A, the system 500 includes a host system 502 in communication with one or more first client devices C₁, C₂, . . . , Cᵢ 504 (hereinafter referred to as “clients 504”) via a first communication network 506. The host system 502 is located in a first country as shown in the example of FIG. 5A, but may be located in another type of demarcation boundary as consistent with this disclosure. Additionally, the host system 502 is in communication with or one or more second client devices P₁, P₂, . . . , Pᵢ 508 (hereinafter referred to as “clients 508”) via a second communications network 510. The communications networks 506, 510 may be the Internet, although it will be appreciated that any public or private communication network, using wired or wireless channels, suitable for enabling the electronic exchange of information between the clients 504, 508 and the host system 502 may be utilized.

The host system 502 may be implemented by a healthcare insurance provider or healthcare services provider (hereinafter referred to as “host institution”) and is configured to provide network-based product and service features to the clients 504, 508 and users (e.g., healthcare providers seeking payment of healthcare services from the host institution 502) associated with the clients 504, 508. The clients 504, 508 may include any form of mobile or portable device and any suitable network-enabled devices such as, for example, PCs, laptop computers, palmtop computers, mobile phones, mobile tablets, PDAs, etc. configured to transmit and receive information via the communications networks 506, 510 using wired or wireless connections.

In some embodiments, the host system 502 may be based on a tiered network architecture, and includes a web server 512 (Tier 1), an application server 514 (Tier 2), and a database server 516 (Tier 3). The web server 512 corresponds to the first tier of the host system 502 and is configured to communicate with the communication networks 506, 510 via border firewalls 518, 520, respectively, and with the application server 514 via an application firewall 522. The web server 512 may be configured to accept information requests, such as, for example, HTTP requests, from one or more of the clients 504, 508 via the communication networks 506, 510 and provide responses thereto. The responses may include, for example, HTTP responses including static and/or dynamic HTML documents for providing a user interface (“UI”) to users via the clients 504, 508. Additionally, the web server 512 may further be configured to authenticate each user before allowing access to a UI and other resources associated with the host system 502. Authentication may be performed, for example, by the user inputting a user name and a password.

The application server 514 corresponds to the second tier of the host system 502 and is configured to communicate with the web server 512 via the application firewall 522, and with the database server 516 via an internal firewall 524. The application server 514 may host one or more applications executing logic to provide healthcare insurance payment associated features to each user via their respective UI. The application server 514 receives user-entered information (e.g., user name and password associated with the user and a request to access particular healthcare insurance payment or reimbursement features) from the UI of each of the clients 504, 508 via the web server 512. Based on this and other information received from the clients 504, 508, applications hosted by the application server 514 may be invoked to perform financial and other transactions (e.g., transfer funds between accounts, retrieve account balances, receive payments, create new accounts, process claims, create adherent accounts, etc.) and generate corresponding informational content (e.g., transfer confirmations, account balance information, payment confirmation, account creation confirmation, claims processing information, claims payment information, claim approval/denial information, etc.). Information regarding such transactions and claims may be communicated to the web server 512 and subsequently presented to the users using, for example, a dynamic web page of the UI.

The database server 516 corresponds to the third tier of the host system 502 and is configured to communicate with the application server 514 via the internal firewall 524. The database server 516 manages one or more databases DB₁ 526 (hereinafter referred to as “databases 526”) which store data to support one or more applications hosted by the application server 514 or elsewhere. Such databases 526 may include, for example, host information databases, adherent information databases, coverage information databases, adherent account configuration databases, client databases, document identification/authentication databases, user information databases, user identification/authentication databases, user preferences/settings databases, as well as databases for storing other settings and/or configuration data. Database information requested by a particular application is retrieved from the databases 526 by the database server 516, communicated to the requesting application, and updated by the database server 516 as needed.

The clients 504, 508, as discussed above, may be PCs and/or other network-enabled devices (e.g., cell phones, mobile phones, mobile tablets, PDAs, etc.) configured to transmit and receive information via the communication networks 506, 510 using a wired or wireless connection. The clients 504, 508 may include a suitable browser software application (e.g., Internet Explorer, Internet Explorer Mobile, Firefox, Blazer, etc.) for enabling the user to display and interact with information exchanged via the communication networks 506, 510. The clients 504, 508 may thus access and navigate static and/or dynamic HTML documents of the UI.

Further, as shown in FIG. 5B, the system 500 may include an outside system 532 in communication with one or more client devices P₁, P₂, . . . , Pᵢ 528 (hereinafter referred to as “clients 528”) via an additional communication network 536. The outside system 532 is located in a second country as shown in the example of FIG. 5B, but may be located in another type of demarcation boundary as consistent with this disclosure. Additionally, the outside system 532 may be in communication with or one or more second client devices (not shown) via the communications network 536 or another communications network. The communications network 536 may be the Internet, although it will be appreciated that any public or private communication network, using wired or wireless channels, suitable for enabling the electronic exchange of information between the clients 528 and the outside system 532 may be utilized.

The outside system 532 may be implemented by a healthcare insurance provider or healthcare services provider (hereinafter referred to as “healthcare institution”) and is configured to provide network-based product and service features to the clients 528 and users (e.g., healthcare providers seeking payment of healthcare services from the host institution 502 and/or healthcare institution 532) associated with the clients 528. The clients 528 may include any form of mobile or portable device and any suitable network-enabled devices such as, for example, PCs, laptop computers, palmtop computers, mobile phones, mobile tablets, PDAs, etc. configured to transmit and receive information via the communications networks 536 using wired or wireless connections.

Similar to the embodiment shown in FIG. 5A, in some embodiments, the outside system 532 and may be based on a tiered network architecture, and includes a web server 534 (Tier 1), an application server 544 (Tier 2), and a database server 546 (Tier 3), respectively. The web server 534 corresponds to the first tier of the outside system 532 and is configured to communicate with the communication network 536 via border firewall 538 and with the application server 544 via an application firewall 542. The web server 534 may be configured to accept information requests, such as, for example, HTTP requests, from one or more of the clients 528 via the communication network 536 and provide responses thereto. The responses may include, for example, HTTP responses including static and/or dynamic HTML documents for providing a user interface (“UI”) to users via the clients 528. Additionally, the web server 534 may further be configured to authenticate each user before allowing access to a UI and other resources associated with the outside system 532. Authentication may be performed, for example, by the user inputting a user name and a password.

The application server 544 corresponds to the second tier of the outside system 532 and is configured to communicate with the web server 534 via the application firewall 542, and with the database server 546 via an internal firewall 545. The application server 544 may host one or more applications executing logic to provide healthcare insurance payment associated features to each user via their respective UI. The application server 544 receives user-entered information (e.g., user name and password associated with the user and a request to access particular healthcare insurance payment or reimbursement features) from the UI of each of the clients 528 via the web server 534. Based on this and other information received from the clients 528, applications hosted by the application server 544 may be invoked to perform financial and other transactions (e.g., transfer funds between accounts, retrieve account balances, receive payments, create new accounts, process claims, create adherent accounts, etc.) and generate corresponding informational content (e.g., transfer confirmations, account balance information, payment confirmation, account creation confirmation, claims processing information, claims payment information, claim approval/denial information, etc.). Information regarding such transactions and claims may be communicated to the web server 534 and subsequently presented to the users using, for example, a dynamic web page of a UI.

The database server 546 corresponds to the third tier of the outside system 532 and is configured to communicate with the application server 544 via the internal firewall 545. The database server 546 manages database DB₂ 556 (hereinafter referred to as “databases 556”) which store data to support one or more applications hosted by the application server 544 or elsewhere. While not shown, other databases may also be present and managed by the database server 546. Such databases 556 may include, for example, host information databases, adherent information databases, coverage information databases, adherent account configuration databases, client databases, document identification/authentication databases, user information databases, user identification/authentication databases, user preferences/settings databases, as well as databases for storing other settings and/or configuration data. Database information requested by a particular application is retrieved from the databases 556 by the database server 546, communicated to the requesting application, and updated by the database server 546 as needed.

The clients 528, as discussed above, may be PCs and/or other network-enabled devices (e.g., cell phones, mobile phones, mobile tablets, PDAs, etc.) configured to transmit and receive information via the communication network 536 using a wired or wireless connection. The clients 538 may include a suitable browser software application (e.g., Internet Explorer, Internet Explorer Mobile, Firefox, Blazer, etc.) for enabling the user to display and interact with information exchanged via the communication network 536. The clients 528 may thus access and navigate static and/or dynamic HTML documents of a UI.

The host system 502 and outside system 532 may communicate via communication network 511. Additionally, the clients 528 may communicate directly with the host system 502 via communication networks 536 and 511. The communications network 511 may be the Internet, although it will be appreciated that any public or private communication network, using wired or wireless channels, suitable for enabling the electronic exchange of information between the host system 502 and outside system 532 may be utilized. A firewall may or may not be applied at other end of the communication network 511 for host system 502 and outside system 532, respectively.

As would be appreciated by one skilled in the relevant art(s) and described below with reference to FIG. 6, part or all of one or more aspects of the methods and systems discussed herein may be distributed as an article of manufacture that itself comprises a computer readable medium having computer readable code means embodied thereon.

The computer readable program code means is operable, in conjunction with a computer system, to carry out all or some of the steps to perform the methods or create the apparatuses discussed herein. The computer readable medium may be a recordable medium (e.g., hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, for example, by processing capability on mobile device, POS terminal, payment processor, acquirer, issuer, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

Aspects of the present disclosure shown in FIGS. 1-4, or any part(s) or function(s) thereof, may be implemented using hardware, software modules, firmware, tangible computer readable media having instructions stored thereon, or a combination thereof and may be implemented in one or more computer systems or other processing systems.

FIG. 6 illustrates an example computer system 600 in which embodiments of the present disclosure, or portions thereof, may be implemented as computer-readable code. For example, the various aspects and computer devices used to effectuate the steps shown in the flowcharts depicted in FIGS. 1-4 can be implemented in the computer system 600 using hardware, software, firmware, non-transitory computer readable media having instructions stored thereon, or a combination thereof and may be implemented in one or more computer systems or other processing systems. Hardware, software, or any combination of such may embody any of the modules and components used to implement the systems and methods described below and in FIGS. 1-4.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments. A processor device may be a single processor, a plurality of processors, or combinations thereof. Processor devices may have one or more processor “cores”.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

The computer system 600 includes a display 630 connected to a communications infrastructure 606 via a display interface 602. In an embodiment, the display 630, in conjunction with the display interface 602, provides a user interface (UI) for clients and purchasers. The computer system 600 also includes a processor device 604, which may be a special purpose or a general purpose processor device. As will be appreciated by persons skilled in the relevant art, the processor device 604 may also be a single processor in a multi-core/multiprocessor system, such system operating alone, or in a cluster of computing devices operating in a cluster or server farm. The processor device 604 is connected to the communication infrastructure 606, for example, by a bus, message queue, network, or multi-core message-passing scheme.

The computer system 600 also includes a main memory 608 (e.g., random access memory, read only memory, etc., and may also include a secondary memory 610. Secondary memory 610 may include, for example, a hard disk drive 612 and a removable storage drive 614, such as, for example, a floppy disk drive, a magnetic tape drive, an optical disk drive, a flash memory, etc.

The removable storage drive 614 may read from and/or writes to a removable storage unit 618 in a well-known manner. The removable storage unit 618 may comprise a floppy disk, magnetic tape, optical disk, Universal Serial Bus (“USB”) drive, flash drive, memory stick, etc. which is read by and written to by removable storage drive 614. As will be appreciated by persons skilled in the relevant art, the removable storage unit 618 includes a non-transitory computer usable storage medium having stored therein computer software and/or data.

In alternative implementations, the secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system 600.

The computer system 600 may also include a communications interface 624. The communications interface 624 allows software and data to be transferred between the computer system 600 and external devices. The communications interface 624 may include a modem, a network interface (such as an Ethernet card), a communications port, a PCMCIA slot and card, or the like. Software and data transferred via the communications interface 624 may be in the form of signals 628, which may be electronic, electromagnetic, optical, or other signals capable of being received by communications interface 624. These signals 628 may be provided to the communications interface 624 via a communications path 626. The communications path 226 carries the signals 628 and may be implemented using wire or cable, fiber optics, a phone line, a cellular/wireless phone link, an RF link or other communications channels.

In this document, the terms “computer program medium,” “non-transitory computer readable medium,” and “computer usable medium” are used to generally refer to tangible media such as removable storage unit 618, removable storage unit 622, and a hard disk installed in hard disk drive 612. Signals carried over the communications path 626 can also embody the logic described herein. The computer program medium and computer usable medium can also refer to memories, such as main memory 608 and secondary memory 610, which can be memory semiconductors (e.g., DRAMs, etc.). These computer program products are means for providing software to computer system 600.

Computer programs (also called computer control logic and software) are generally stored in a main memory 608 and/or secondary memory 610. The computer programs may also be received via the communications interface 624. Such computer programs, when executed, enable computer system 600 to become a specific purpose computer able to implement the present disclosure as discussed herein. In particular, the computer programs, when executed, enable the processor device 604 to implement the processes of the present disclosure discussed above. Accordingly, such computer programs represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for automated cross border healthcare services. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Although the present disclosure is illustrated and described herein with reference to specific embodiments, the disclosure is not intended to be limited to the details shown. It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this disclosure, which is to be given the full breadth thereof. Additionally, the disclosure of a range of values is a disclosure of every numerical value within that range.

It should also be understood that all references identified and/or referenced herein are incorporated fully by reference herein in there entireties.

I/We claim:

1. A method for providing healthcare insurance services to a beneficiary outside of a home boundary of the beneficiary, the method comprising:
receiving, by a computing system including a processor and a data storage medium, a request to provide healthcare insurance coverage services for healthcare services provided, or to be provided, to a beneficiary from a healthcare provider at a first location;
determining, by the computing system, whether the first location of the healthcare provider is within or outside of the home boundary of the beneficiary; and
if the first location is outside of the home boundary of the beneficiary:
determining, by the computing system, an eligibility of the beneficiary based on at least the healthcare provider and the first location of the healthcare provider; and
providing, by the computing system, an insurance coverage amount to the healthcare provider at the first location based on the determination of the eligibility of the beneficiary.

2. The method of claim 1, wherein determining the eligibility of the beneficiary comprises determining, by the computing system, a regulatory structure of the first location applicable to the healthcare services.

3. The method of claim 1, further comprising creating a profile for the beneficiary and storing the profile in a database.

4. The method of claim 3, wherein the database is controlled by a healthcare insurer providing the coverage amount to the healthcare provider.

5. The method of claim 1, further comprising creating a claim for healthcare services provided by the healthcare provider at the first location outside of the home boundary of the beneficiary by referencing information about the beneficiary in a database and computing an amount of administrative fees for a cross border claim for the healthcare services.

6. The method of claim 1, wherein the eligibility of the beneficiary is dependent upon a country in which the first location of the healthcare provider is located.

7. The method of claim 1, further comprising providing the beneficiary with a healthcare access card that provides access to payment for the healthcare services received, or to be received, by the beneficiary outside of the home boundary of the beneficiary.

8. The method of claim 1, wherein the healthcare services comprise an elective healthcare procedure, and wherein providing the coverage amount comprises determining, by the computing system, the elective healthcare procedure to be provided to the beneficiary.

9. The method of claim 1, wherein the beneficiary is an enrollee of a coverage program controlled and operated by a healthcare insurer.

10. The method of claim 1, wherein providing the coverage amount to the healthcare provider at the first location is also based on the healthcare services to be provided to the beneficiary from the healthcare provider.

11. The method of claim 1, wherein the coverage amount is a predetermined coverage amount.

12. A system for providing healthcare insurance services to a beneficiary outside of a home boundary of the beneficiary, the system comprising:
a computer system comprising at least one processor and an operably connected data storage medium, wherein the at least one processor is configured for receiving a request to provide healthcare insurance services for healthcare services provided, or to be provided, to a beneficiary from a healthcare provider at a first location,
wherein the at least one processor is further configured for:
determining whether the first location of the healthcare provider is within or outside of the home boundary of the beneficiary; and
if the first location is outside of the home boundary of the beneficiary:
determining an eligibility of the beneficiary based on at least the healthcare provider and the first location of the healthcare provider; and
providing an insurance coverage amount to the healthcare provider at the first location based on the determination of the eligibility of the beneficiary.

13. The system of claim 12, wherein the at least one processor determines the eligibility of the beneficiary based on at least a regulatory structure of the first location applicable to the healthcare services.

14. The system of claim 12, wherein the at least one processor creates a profile for the beneficiary and stores the profile in a database.

15. The system of claim 12, wherein the computer system is a first computer system, and wherein the first computer system receives the request to provide healthcare insurance services for healthcare services provided, or to be provided, to a beneficiary from a second computer device based on a transaction associated with a healthcare access card that provides access to payment for the healthcare services received, or to be received, by the beneficiary outside of the home boundary of the beneficiary.

16. A method for providing healthcare insurance services to a beneficiary outside of a home country of the beneficiary, the method comprising:
receiving, by a computing system including a processor and a data storage medium, a request to provide healthcare insurance services for healthcare service provided, or to be provided, to a beneficiary from a healthcare provider in a first country;
determining, by the computing system, whether the first country of the healthcare provider is within or outside of the home country of the beneficiary; and
if the first country is outside of the home country of the beneficiary:
determining, by the computing system, an eligibility of the beneficiary based on at least the healthcare provider and the first country of the healthcare provider; and
providing, by the computing system, an insurance coverage amount to the healthcare provider at the first country based on the determination of the eligibility of the beneficiary,
wherein providing the insurance coverage amount comprises determining, by the computing system, at least one of a legal structure of the first country, a regulatory structure of the first country, a taxation structure in the first country, and a type of healthcare services provided, or to be provided, to the beneficiary.

17. The method of claim 16, wherein the type of healthcare services comprises at least one of a prescription for medicine, an elective surgical procedure, general physician services, and emergency treatment services.

18. The method of claim 16, further comprising processing, by the computing system, a claim for the insurance coverage amount based on a contract specified for the home country of the beneficiary.

19. The method of claim 16, further comprising computing, by the computing system, administration fees for providing the insurance coverage amount to the healthcare provider at the first country based on the determination of the eligibility of the beneficiary.

20. The method of claim 16, further comprising receiving, by the computing system, an endorsement for the beneficiary in a healthcare network operated by a healthcare insurer and updating a database based on the endorsement for the beneficiary.

21. The method of claim 16, further comprising periodically updating a database based on changes in at least one of the legal structure of the first country, the regulatory structure of the first country, a taxation structure in the first country, and types of healthcare services offered in the first country.
